(19) United States
(12) Patent Application Publication
(10) Pub. No.: US 2015/0188271 A1
(43) Pub. Date: Jul. 2, 2015

(54) EXTRACTION TOOL FACILITATING SEPARATION OF A COVER FROM AN ELECTRICAL CONNECTOR

(71) Applicant: FOXCONN INTERCONNECT TECHNOLOGY LIMITED, Grand Cayman, KY (US)

(72) Inventors: DING-CHERNG CHEN, New Taipei (TW); MIN-HAN LIN, New Taipei (TW); CHIEN-JEN TING, New Taipei (TW)

(21) Appl. No.: 14/578,821

(22) Filed: Dec. 22, 2014

(30) Foreign Application Priority Data
Dec. 30, 2013 (CN) 201310741049.8

(51) Int. Cl. H01R 43/00

(52) U.S. Cl. CPC H01R 43/00

(57) ABSTRACT

An extraction tool (11, 21), used for separating a cover (12) from an electrical connector (13), includes a main portion (110, 210) and a pair of rigid beams (112, 212) extending upwardly from two opposite edges of the main portions to define an opening (111, 211) therebetween. The cover has a base portion (121, 221) and a tube portion (122, 222) extending upwardly from the base portion. The opening is adapted to receive the base portion and engage with the cover.

### BACKGROUND OF THE INVENTION

1. Field of the Invention

The present invention relates generally to an extraction tool, and more particularly to an extraction tool facilitating separation of a cover from an electrical connector.

2. Description of Related Arts

Taiwan Pat. No. M336574, issued on Jul. 11, 2008, discloses an electrical connector and a protective cover. The cover is secured to the electrical connector before the electrical connector is assembled to an electronic device for dust prevention and other damage. Because of miniaturization of electrical connectors, the cover has a small size such that it is not easy to be removed by a user's fingers.

An extraction tool facilitating separation of a cover from an electrical connector is desired.

### SUMMARY OF THE INVENTION

Accordingly, an object of the present invention is to provide an extraction tool facilitating separation of a cover from an electrical connector.

To achieve the above object, an extraction tool, used for separating a cover from an electrical connector, includes a main portion and a pair of rigid beams extending upwardly from two opposite edges of the main portions to define an opening therebetween. The cover has a base portion and a tube portion extending upwardly from the base portion. The opening is adapted to receive the base portion and engage with the cover.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of an extraction tool engaged with a cover when the cover is assembled on an electrical connector in a first embodiment constructed in accordance with the present invention;

FIG. 2 is a perspective view of the extraction tool which has separated the cover from the electrical connector of FIG. 1;

FIG. 3 is a perspective, fully exploded view of the extraction tool, the cover, and the electrical connector of FIG. 1;

FIG. 4 is a perspective, assembled view of an extraction tool engaged with a cover when the cover is assembled on an electrical connector in a second embodiment constructed in accordance with the present invention;

FIG. 5 is a perspective view of the extraction tool which has separated the cover from the electrical connector of FIG. 4;

FIG. 6 is a perspective, fully exploded view of the extraction tool, the cover, and the electrical connector of FIG. 4; and

FIG. 7 is a right side, elevational view of FIG. 4.

### DETAILED DESCRIPTION OF THE PREFERRED EMBODIMENT

Reference will now be made in detail to the preferred embodiment of the present invention.

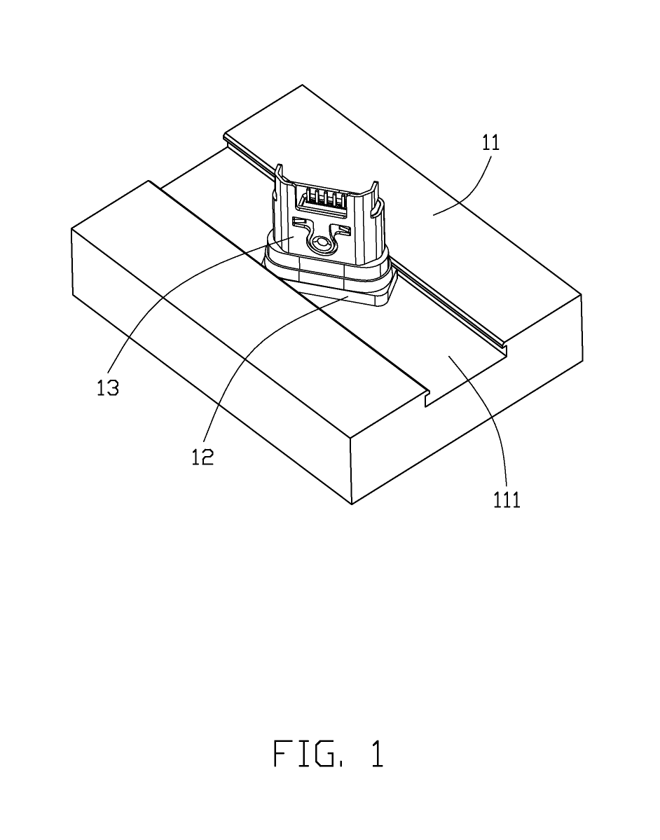

Referring to FIGS. 1-3, an extraction tool 11 of the present invention in a first embodiment is used for separating a cover 12 from an electrical connector 13 when the electrical connector 13 is assembled on an electronic device (not shown).

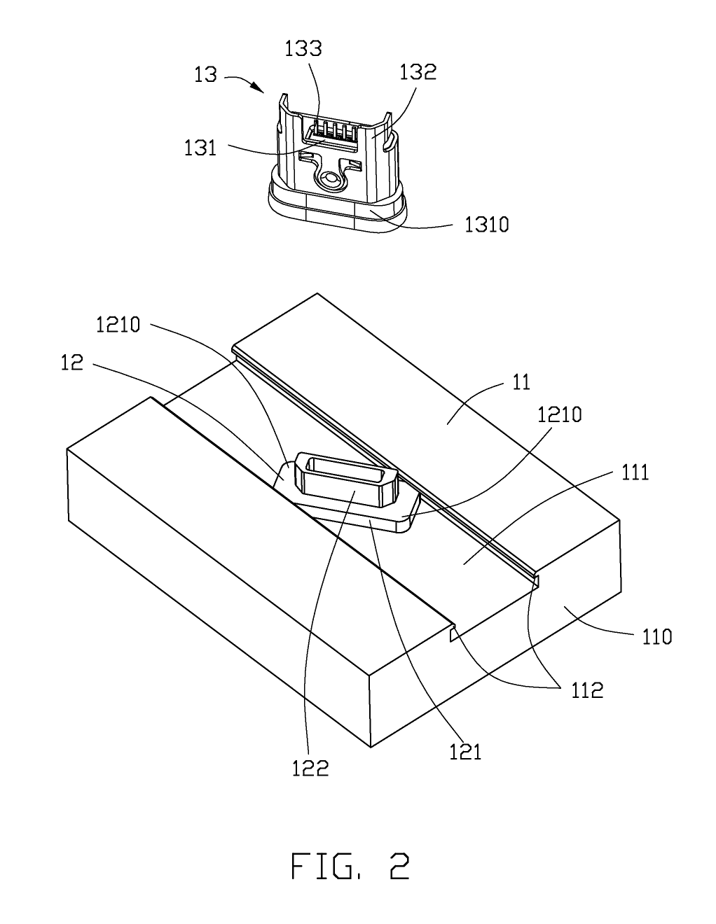

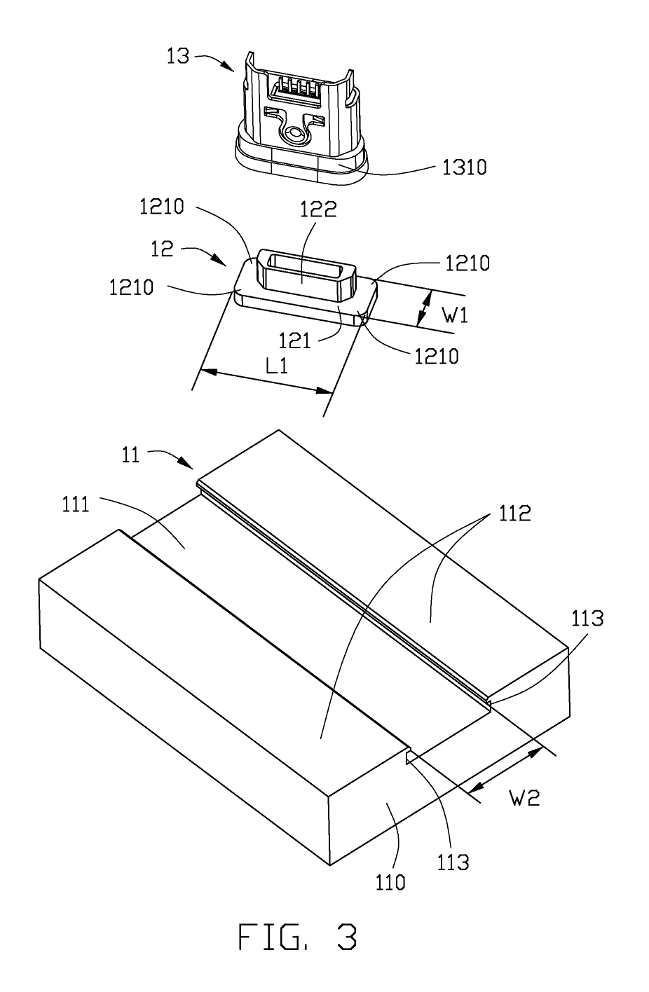

Referring to FIGS. 2 and 3, the electrical connector 13 comprises an insulative body 131, a plurality of contacts 133 retained in the insulative body 131, and a metal shell 132 covering the insulative body 131. The insulative body 131 comprises a case portion 1310 extending forwardly out of the metal shell 132. Notably, the electrical connector 13 includes a mating opening (not shown) in the case portion 1310 for receiving the complementary connector.

The cover 12 comprises a base portion 121 and a tube portion 122 extending upwardly from the base portion 121. The base portion 121 is substantially rectangular shaped and has four corner portions 1210 exposed beside the tube portion 122. The tube portion 122 is received in the mating opening of the case portion 1310, the base portion 121 bears against a front face of the case portion 1310, and the four corner portions 1210 are disposed around the case portion 1310. The base portion 121 has a length named L1 and a width named W1. L1 is larger than W1.

The extraction tool 11 has a main portion 110, and a pair of rigid beams 112 extending upwardly and then inwardly from two opposite edges of the main portions 110 to define a pair of opposite facing slots 113. The rigid beams 112 space from each other for defining an opening 111 therebetween. The opening 111 extends along a lengthwise direction. The opposite facing slots 113 are located at two sides of the opening 111 and communicated with the opening 111. The opening 111 has a width named W2 along a transverse direction perpendicular to the lengthwise direction. W2 is larger than W1 but smaller than a square root of a numeral which is L1*L1 plus R1*R1.

The electrical connector 13 with the cover 12 assembled thereto is inserted into the opening 111 of the extraction tool 11. Because W2 is larger than W1, the cover 12 is easily inserted into the opening with the length edges L1 of the base portion 121 not interfering with the rigid beams 112. The extraction tool 11 is rotated along a circle direction when a user operated on the extraction tool 11 to make sure two of the corner portions 1210 on the diagonal line of the base portion 121 are received in the opposite facing slots 113 and bear against the rigid beams 112. The user easily separates the cover 12 from the electrical connector 13 under a small force via the extraction tool 11 along a vertical direction perpendicular to both the lengthwise direction and the transverse direction. From another viewpoint, the base portion 121 essentially provides a step structure with regard to the tube portion 122, and the cover 12 may be withdrawn from the connector 13 when the electrical connector 13 and the associated cover 12 are rotated to have the step structure invade the opposite facing slots 113 and an upward withdrawal force is applied upon the connector 13.

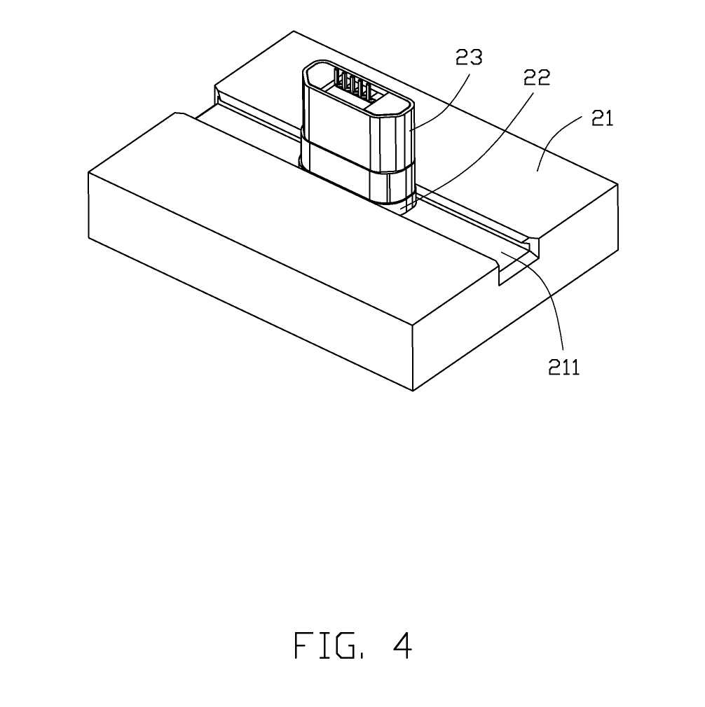

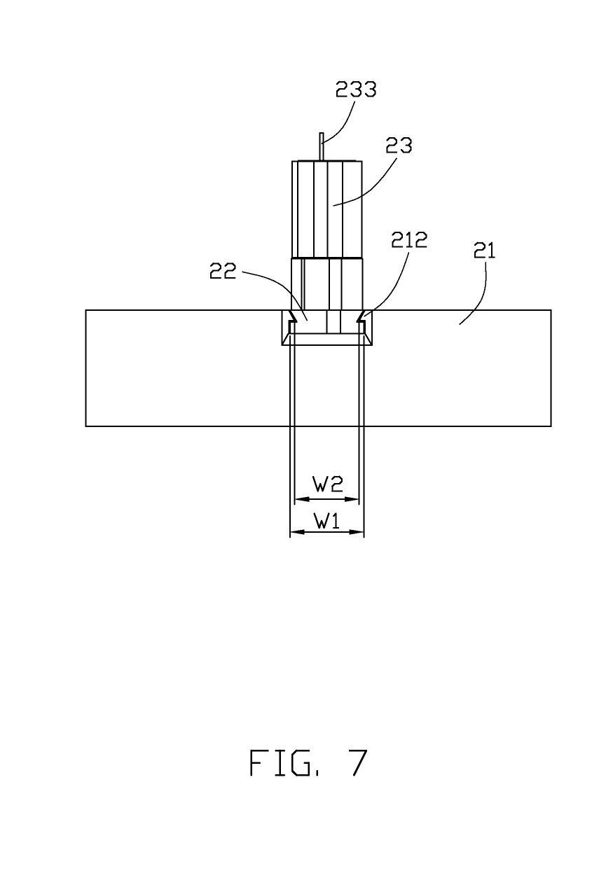

Referring to FIGS. 4-7, an extraction tool 21 of the present invention in a second embodiment is used for separating a cover 22 from an electrical connector 23 when the electrical connector 23 is assembled on an electronic device (not shown).

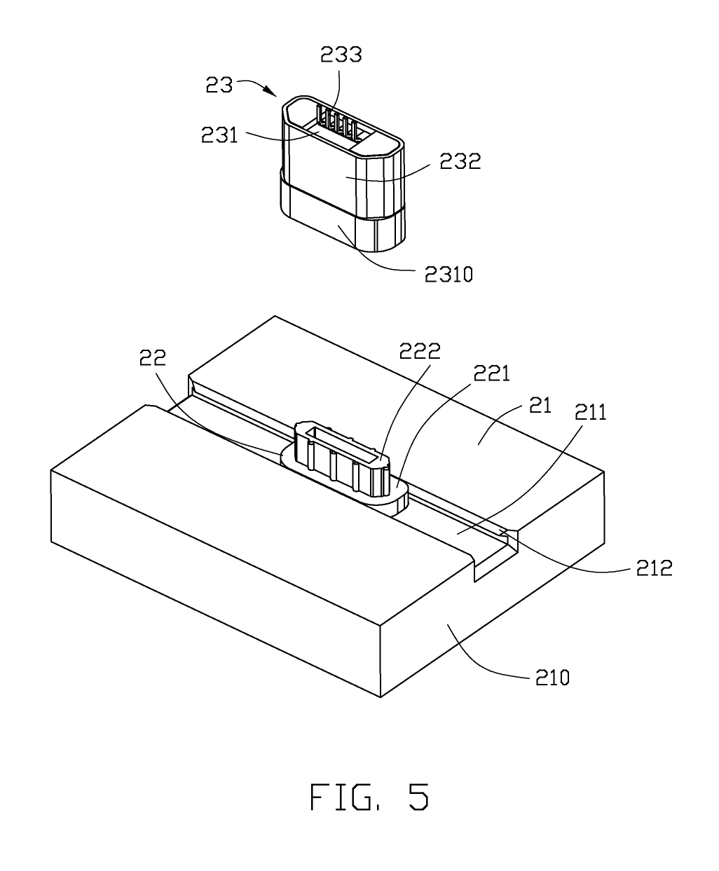

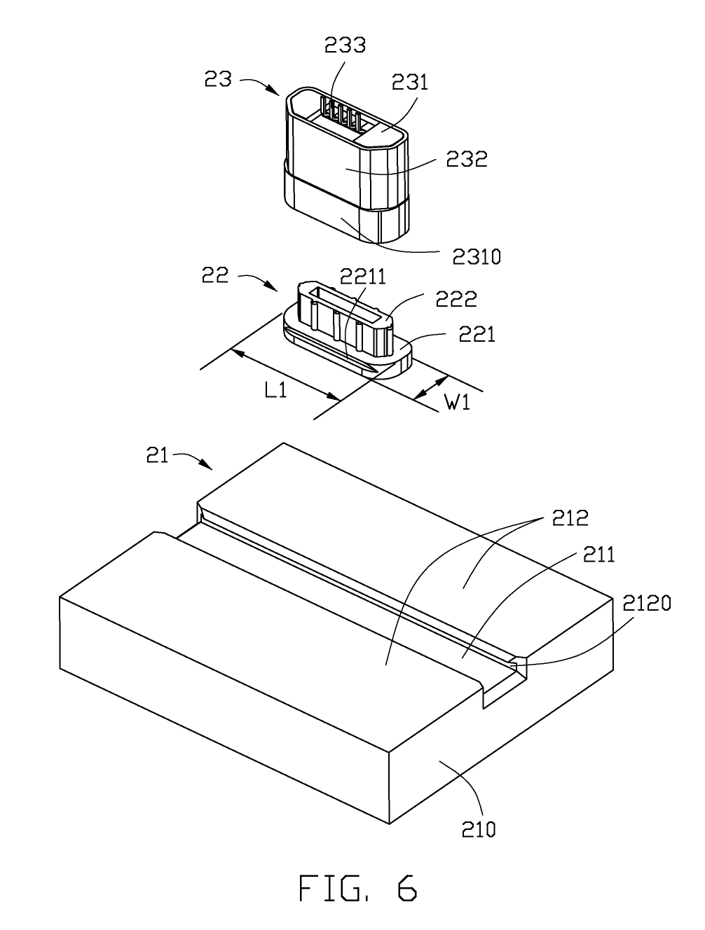

Referring to FIGS. 5 and 6, the electrical connector 23 comprises an insulative body 231, a plurality of contacts 233 retained in the insulative body 231, and a metal shell 232 covering the insulative body 231. The insulative body 231 comprises a case portion 2310 extending forwardly out of the metal shell 232.

The cover 22 comprises a base portion 221 and a tube portion 222 extending upwardly from the base portion 221. The base portion 22 is substantially rectangular shaped and has four corner portions 2210 exposed beside the tube portion 222. The tube portion 222 is received in the case portion 2310, the base portion 221 bears against a front face of the case portion 2310, and the four corner portions 2210 are disposed around the case portion 2310. The base portion 221 has a length named L1 and a width named W1. L1 is larger than W1. The base portion 221 has a pair of notches 2211 at two length edges L1 with the corresponding step structures (not labeled) above said notch 2211.

The extraction tool 21 has a main portion 210, and a pair of rigid beams 212 extending upwardly from two opposite edges of the main portions 110. The rigid beams 212 are recessed inwardly to have a pair of opposite facing (inward) slots 2120 so as to form a pair of shoulder structures (not labeled) above the slots 2120. The rigid beams 112 space from each other for defining an upward opening or channel 211 therebetween. The opening 211 extends along a lengthwise direction. The opposite facing slots 2120 are located at two sides of the opening 211 and communicated with the opening 211. The opening 211 has a width named W2 along a transverse direction perpendicular to the lengthwise direction. W2 is smaller than W1.

The electrical connector 23 with the cover 22 assembled thereto is inserted into the opening 211 of the extraction tool 21 along the lengthwise direction. Therefore, the four corner portions 2210 of the cover 22 below the notches 2211 extend into the corresponding opposite facing slots 2120 of the cover 21. The cover 22 is engaged with the extraction tool 21 without rotation of the extraction tool 21. The user easily separates the cover 22 from the electrical connector 23 under a small force upon the electrical connector 23 along the vertical direction.

The extraction tools 11, 12 in the two embodiments of present invention, each has an opening 111, 211. The covers 12, 22 are partly received in the openings 111, 121 of the extraction tools 11, 12 so that a pair of rigid beams 112, 212 of the extraction tools 11, 12 are engaged with the covers 12, 22 for facilitating user's operation on the extraction tools 11, 12 and then, separating the covers 12, 22 from the electrical connectors 13, 23.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An extraction tool, used for separating a cover from an electrical connector, the cover having a base portion and a tube portion extending upwardly from the base portion, the extraction tool comprising:
a main portion; and
a pair of rigid beams extending upwardly from two opposite edges of the main portion to define an opening therebetween;
wherein the opening is adapted to receive the base portion and engage with the cover.

2. The extraction tool as claimed in claim 1, wherein a pair of opposite facing slots is formed on the rigid beams, four corner portions are exposed on the base portion and beside the tube portion, and at least two corner portions are received in the opposite facing slots and bear against the rigid beams.

3. The extraction tool as claimed in claim 2, wherein the opposite facing slots are communicated with the opening.

4. The extraction tool as claimed in claim 3, wherein the opening has a width greater than a width of the base portion.

5. The extraction tool as claimed in claim 4, wherein the width of the opening is smaller than a length of the base portion, and the opposite facing slots receive two of the corner portions on the diagonal line of the base portion.

6. The extraction tool as claimed in claim 3, wherein the width of the opening is greater than a length of the base portion.

7. The extraction tool as claimed in claim 6, wherein the rigid beams engage four corner portions of the base portion.

8. A method of extraction of a dust cover from a mating opening of an electrical connector, comprising steps of:
providing the dust cover with a base portion with a tube portion extending therefrom wherein the tube portion extends into the mating opening of the electrical connector and the base portion confronting a flange of the electrical connector from which said mating opening is recessed;
forming a pair of step structures on two opposite lateral sides of the dust cover;
providing an extraction tool with an upward channel and a pair of shoulder structures by two opposite lateral sides of the channel, said channel forming one end communicating with an exterior via a side face of the extraction tool;
sliding the electrical connector and the associated dust cover, in an upside-down manner, into the channel from said end with the dust cover being received within the channel and moved with a distance along said channel; and
having the step structures and the shoulder structures confront with each other and applying a withdrawal force upon the electrical connector to remove the electrical connector from the dust cover.

9. The method as claimed in claim 8, wherein the channel is dimensioned to receive the base portion when said dust cover is moved along the channel.

10. The method as claimed in claim 9, wherein the electrical connector defines a lengthwise direction and a transverse direction perpendicular to each other, and the lengthwise direction complies with an extending direction of said channel.

11. The method as claimed in claim 10, wherein a width of the channel is much larger than a dimension of the base portion of the dust cover in the transverse direction so as to rotate the electrical connector and the associated dust cover to have the step structures and the shoulder structures confront each other in a vertical direction perpendicular to both said lengthwise direction and said transverse direction.

12. The method as claimed in claim 10, wherein width of the channel is little larger than a dimension of the base portion of the dust cover in the transverse direction so as to have, without rotation of the electrical connector and the associated dust cover, the step structure and the shoulder structure confront each other in a vertical direction perpendicular to both said lengthwise direction and said transverse direction.

13. The method as claimed in claim 8, wherein the step structures are formed on diagonally opposite corners of the dust cover so as to confront the corresponding shoulder structures via rotation of the dust cover about an axis extending along a vertical direction.

14. The method as claimed in claim 8, wherein the step structures are formed on two opposite lengthwise sides of the base portion so as to confront the corresponding shoulder structure without rotation of the dust cover about an axis extending along a vertical direction.

15. An extraction tool for removing a dust cover from an electrical connector, wherein said dust cover has a base portion with a pair of step structures thereof, and a tube portion extending from the base portion to be received within the electrical connector, comprising:
a main portion defining an upper face and a lateral face;
a channel formed in the main portion and extending through the upper face in a vertical direction to communicating with an exterior in a vertical direction, and through the lateral face to communicate with the exterior in a lengthwise direction perpendicular to said vertical direction;
a pair of shoulder structures formed by two sides of the channel in a transverse direction perpendicular to both said vertical direction and said lengthwise direction; wherein
a depth of the channel is dimensioned to be little larger than a height of the base portion for snugly receiving the base portion therein, and a distance between the shoulder structures is dimensioned to be adapted to confront the pair of step structures in the vertical direction, via either rotation or non-rotation of the dust cover with regard to the main portion about an axis extending along the vertical direction.

16. The extraction tool as claimed in claim 15, wherein one end of the channel at the lateral face is equipped with chamfered structures.

17. The extraction tool as claimed in claim 15, wherein said shoulder structures form upward chamfered surfaces facing to each other in the transverse direction.

18. The extraction tool as claimed in claim 15, wherein said channel extends along the lengthwise direction.

19. The extraction tool as claimed in claim 18, wherein said channels extends through the main portion in said lengthwise direction.

20. The extraction tool as claimed in claim 15, wherein the step structures are locate at a level lower than an upper surface of the main portion.
